(19) United States
(12) Patent Application Publication
(10) Pub. No.: US 2017/0043897 A1
(43) Pub. Date: Feb. 16, 2017

(54) Automatic high speed labeling system

(71) Applicants: Mike Mooneyham, Fresno, CA (US); Kevin Guadagnini, Coarsegold, CA (US); Kino Almaraz, Clovis, CA (US); M. Scott Howarth, Clovis, CA (US)

(72) Inventors: Mike Mooneyham, Fresno, CA (US); Kevin Guadagnini, Coarsegold, CA (US); Kino Almaraz, Clovis, CA (US); M. Scott Howarth, Clovis, CA (US)

(21) Appl. No.: 14/756,175

(22) Filed: Aug. 12, 2015

(51) Int. Cl. B65C 3/00; B65C 9/10; B65C 9/18

(52) U.S. Cl. CPC B65C 3/00; B65C 9/1892; B65C 9/105

(57) ABSTRACT

A high speed automatic produce labeling system is provided, having a label dispense cycle of less than 17 milliseconds and capable of dispensing and applying 1,000 labels per minute per lane. First and second direct gear drives are actuated by a single stepper motor. A removable label cassette is driven by the first direct gear drive; the cassette carries a label carrier strip. An improved Geneva wheel drive forms part of the first gear drive which substantially reduces jerk and tearing of the label carrier strip while maintaining high labeling speed. The label cassette includes several quick-change components allowing the system to apply different size labels. An improved tensioning system is provided, minimizing slipping and tearing of the label carrier strip. An improved stripper plate tip actuator is also provided.

### CROSS REFERENCE TO RELATED APPLICATION

This application claims the benefit of and priority from U.S. provisional application Ser. No. 62/043,748 filed Aug. 29, 2014.

### BACKGROUND

This invention pertains generally to the automatic labeling of produce items. Demand for labeling of produce items has increased significantly over the last several decades. As the demand has increased, it has become more important to increase the speed of the labeling machines. The top speed of prior art automatic labeling machines known to applicants is approximately 700 pieces of produce per lane per minute. Typical labeling systems in commercial packhouses utilize 8 to 10 lanes.

Along with the demand for higher labeling speeds, the produce owners have demanded that labeling machines be capable of applying labels of different sizes. To apply labels of different sizes, time consuming changes typically have to be made in the drive mechanism for rotary heads and/or label cassettes. These changes not only take considerable amounts of time, but typically require costly downtime of the rotary drive and require that the user have the appropriate parts necessary to adapt the rotary head drive mechanism and/or the label cassette to a different label size.

The prior art has provided various designs and techniques to increase labeling speed. The Anderson et al U.S. Pat. No. 6,047,755 (the '755 patent) is the closest prior art known to applicants. The '755 patent teaches the use of a single stepper motor for driving two direct drive gear trains; a first gear train driving the rotary head and a second gear train driving the cassette label carrier strip. We have found that the direct gear drive of the '755 patent creates an inherent limitation in the speed at which the label carrier strip can be reliably advanced by the stepwise, rotational speed imparted to the carrier strip by the stepper motor. We have found that at labeling speeds above 700 labels per minute, the label carrier strip either tears or otherwise fails as the stepper motor indexes, or steps, and jerks the label carrier strip. As described below, the present invention has overcome this limitation of the prior art.

One prior art technique for adapting the labeling machine to apply different size labels is taught by the Anderson et al '755 patent noted above. As shown in FIG. 3 of the '755 patent, a sprocket 66 must be removed from the main housing for the rotary head drive mechanism and replaced with a different size sprocket. This technique is time consuming, estimated at 1 hour per lane, and requires costly downtime of the rotary head as noted above.

Accordingly, there is a significant and growing demand for labeling machines capable of both higher speed and a “quick-change” capability for applying labels of different sizes.

### SUMMARY OF THE INVENTION

The present invention accomplishes both of the above stated goals. It provides a labeling speed of approximately 1,000 labels per minute for a given lane, a quantum increase of over 40% greater speed than labelers known to applicants. The invention also provides a “quick-change” system which significantly reduces the time necessary to adapt the labeler to a different size label.

As shown and described below, the present labeler provides a “Geneva” wheel assembly in the drive mechanism for the label carrier strip. The “Geneva” wheel assembly reduces the jerk applied to the label carrier strip as the stepper motor steps or indexes, and then provides a momentary “boost” or acceleration of the label carrier strip, increasing the label dispense speed for a portion of the label dispense cycle while maintaining the timing of the label dispensing. As described below, we have found that the jerk applied to the label carrier strip is the primary reason that the prior art '755 patent mechanism either tears the label carrier strip or allows slippage of the label carrier strip at speeds above 700 labels per minute. The labeling prior art includes a Geneva movement in U.S. Pat. No. 2,528,856, but the present invention utilizes a Geneva wheel assembly in a substantially different way than that prior art.

With respect to using labels of different sizes, the prior art typically requires a modification to the rotary head drive. The present invention eliminates the need to change or adjust parts in the rotary head drive mechanism, which requires labeling down time and often takes considerable time. The present invention allows the operator to simply change a pulley wheel and belt in the label cassette and adjust a scallop wheel in the label cassette. This can be done in a fraction of the time required by known labelers. For example, in a typical packhouse with an 8 or 10 lane prior art labeling system, in order to change all 8 or 10 lanes to apply different size labels, a downtime of all 8 or 10 lanes of about 8 to 10 hours would be typically required. Using the present invention, all 8 or 10 lanes can be converted in about 10 to 15 minutes, only about 3% of the time required in prior art systems. Labeling machine downtime often results in large amounts of produce being downgraded. A labeling system with 8 lanes is capable of labeling about 336,000 produce items per hour, or about 2,500,000 produce items in an 8 hour shift, if running at full capacity. Reducing labeling machine down time prevents such economic losses.

The present invention also provides an improved cassette label carrier strip tensioning mechanism which helps to facilitate a labeling speed of about 1,000 labels per minute per lane. The improved tensioning system helps to prevent the label carrier strip from slipping or tearing, either of which can cause costly down time of the labeler. The improved mechanism holds the label carrier strip against a scallop pulley more firmly and over a larger arc of the scallop pulley circumference, reduces inertia of the tensioning mechanism and reduces unwanted jerking of the label carrier strip.

The present invention provides a system that has the same floor footprint of prior art systems, allowing the new system to be installed in the same location, using the same floor space as prior art systems.

The present invention also eliminates a cam typically used in known labeling systems for lifting the stripper plate each time a label is transferred from the label strip to the tip of a bellow. This feature further reduces the number of moving parts in the label drive. A typical known stripper plate is shown and described in La Mers U.S. Pat. No. 4,217,164.

A primary object of the invention is to provide an automatic produce labeling machine capable of applying 1,000 labels per minute per lane, while minimizing slippage and tearing of the label carrier strip by substantially reducing jerk imparted to the label carrier strip.

Another object is to provide a “quick change” feature to the labeling system allowing the use of different size labels, wherein the label cassette may be opened and parts changed in a few minutes, all without having to stop operation of the rotary head.

A further object is to provide an improved tensioning system that helps minimize tearing or slipping of the label carrier strip.

A further object is to eliminate a cam utilized to cause oscillation of the tip of the label stripping plate by replacing said cam with an adjustable set screw which allows motion of the tip of the stripping plate.

Further objects and advantages will become apparent from the drawings and the following description.

### BRIEF DESCRIPTION OF THE DRAWINGS

FIG. 1 is a perspective view of a typical, prior art labeler, which may be modified by the present invention;

FIG. 2 is a schematic “concept” sketch of the present invention;

FIG. 3 is a schematic illustration of the label cassette drive, wherein an improved Geneva wheel assembly is utilized to create an improved acceleration pattern of the label carrier strip during each label dispense cycle;

FIG. 4A and 4B are a schematics illustrating the vectoral motion of the improved Geneva wheel assembly of FIG. 3;

FIG. 4C is a schematic illustrating the vectoral motion of a prior art Geneva assembly;

FIG. 5 is a graphic illustration comparing the speed and acceleration patterns of the label carrier strip in a prior art system against the same in the present invention;

FIG. 6A is a perspective, assembly view of an improved label cassette having the “quick change” capability to change label size of the present invention;

FIG. 6B is an exploded view of the label cassette shown in FIG. 6A;

FIG. 7 illustrates a prior art tensioning system;

FIG. 8 illustrates the improved tensioning system of the present invention;

FIG. 9 illustrates the prior art cam utilized to oscillate the tip of the label stripper plate for each label dispense cycle;

FIG. 10 illustrates the use of an adjustable stop screw to allow the tip of the stripper plate to oscillate, and whereby the cam is eliminated;

FIG. 11 is a schematic illustration of the direct gear drive for the rotary head;

FIG. 12 is an assembly drawing of the direct gear drive for the rotary head of FIG. 11 with the wall of the housing broken away;

FIG. 13A is an assembly drawing of a portion of the drive for the label cassette of FIG. 3, with the housing wall broken away for clarity; and

FIG. 13B is an assembly drawing of the belt and pulley drive for the label cassette, which is not visible in FIG. 13A.

### DETAILED DESCRIPTION OF THE DRAWINGS

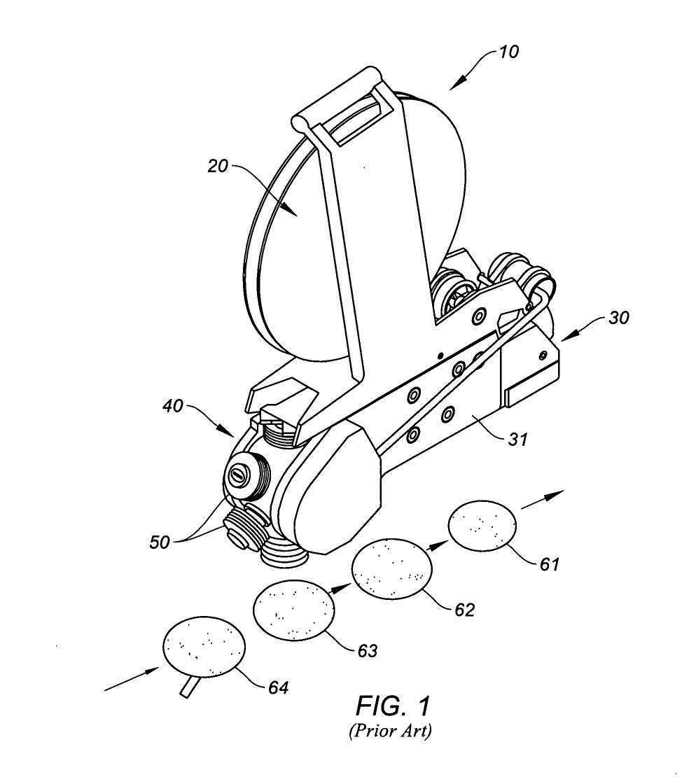

FIG. 1 illustrates the general configuration of a prior art labeling system shown generally as 10. A label cassette 20 is removably carried by a commercially available Sinclair RM6 or SPRM6 machine shown generally as 30. A housing 31 contains the drive mechanism for the label cassette 20 and a rotary head 40, which carries a plurality of flexible bellows 50. The rotating bellows apply labels to produce items 61-64 as known in the art. The present invention provides significant improvements to the drive systems for the label cassette 20 and rotary head 40.

The invention may be used on any standard type labeling machine used in the produce labeling industry for automatically applying adhesive labels to produce, such as the standard Sinclair RM6 (as shown and described in La Mers U.S. Pat. Nos. 4,217,164; 4,303,461; 4,454,180; 4,547,252; and Briggs et al U.S. Pat. No.4,896,793, all of which are incorporated by reference as though set forth in full) or SPRM6 labeling system. The RM6 labeling system is used in the conventional way to apply labels to produce. The Sinclair model RM6 machine is commercially available from Sinclair Systems International, LLC, 3115 South Willow Avenue, Fresno, Calif. 93725.

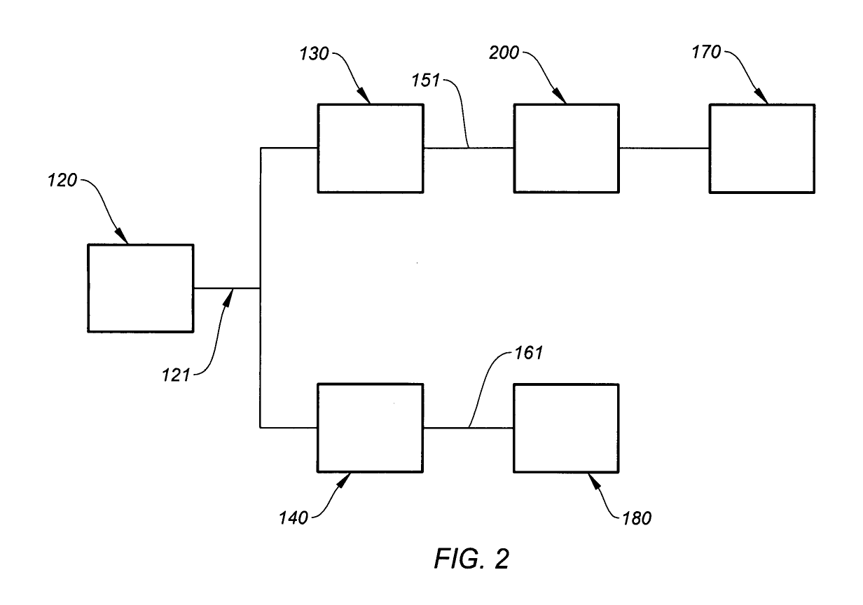

FIG. 2 illustrates the “concept” of the present invention. A single stepper motor 120 actuates first and second direct gear drives 130 and 140, respectively, which in turn rotate drive shafts 151 and 161. Shaft 151 drives the “Geneva” wheel assembly 200. The Geneva wheel assembly in turn drives the label carrier strip, or tape, of the cassette 170. Shaft 161 drives the rotary head 180.

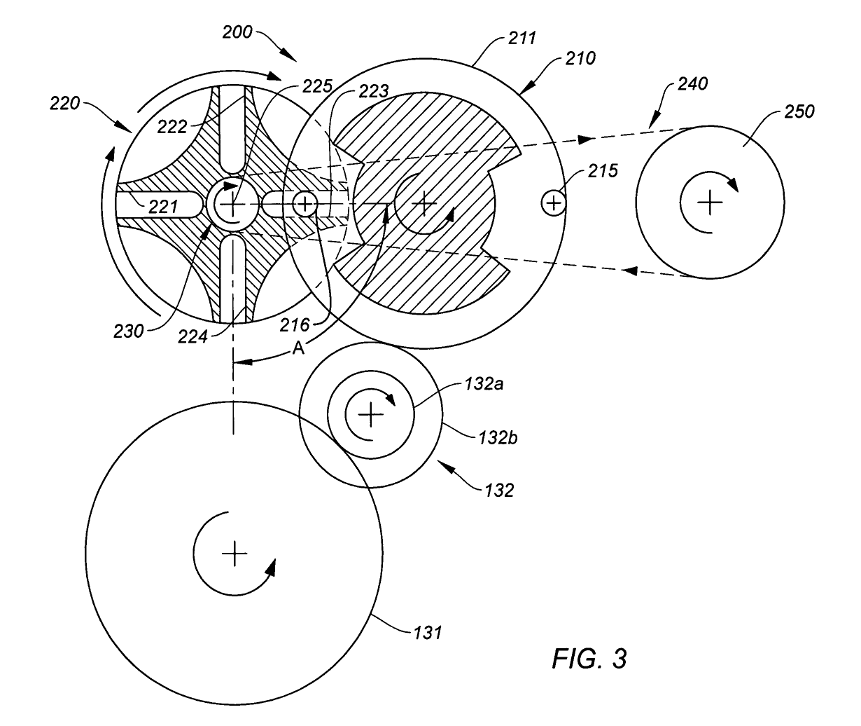

FIG. 3 illustrates the improved first direct gear drive train for the label carrier strip. Drive gear 131 is driven directly by a stepper motor (not shown in FIG. 2). Gear 131 has 80 teeth (not shown) and rotates counter-clockwise as viewed in FIG. 3. Gear 131 in turn drives idler gear 132. Idler gear 132 includes a first ring of teeth 132a having 24 teeth (individual teeth not shown for clarity) that mesh with the teeth of gear 131. Idler gear 132 also includes a second ring of teeth 132b having 48 teeth, which mesh with, and drive, the Geneva wheel assembly 200. Idler gear 132 rotates in a clockwise direction as viewed in FIG. 3.

Geneva wheel assembly 200 includes a Geneva input wheel 210 and Geneva output wheel 220. Input wheel 210 has 80 teeth (not shown for clarity) around its perimeter 211. Input wheel 210 carries a pair of Geneva drive pins 215, 216 which pins are positioned 180° from each other. Input wheel 210 rotates in a counterclockwise direction as viewed in FIG. 3. Geneva output wheel 220 has four radially extending slots 221-224 which are sized to slidably engage pins 215, 216. Output wheel 220 rotates about axis 225 in a clockwise direction as viewed in FIG. 3. Output wheel 220 is caused to rotate by pins 215, 216 as input wheel 211 is driven by stepper motor 20 and gears 131, 132.

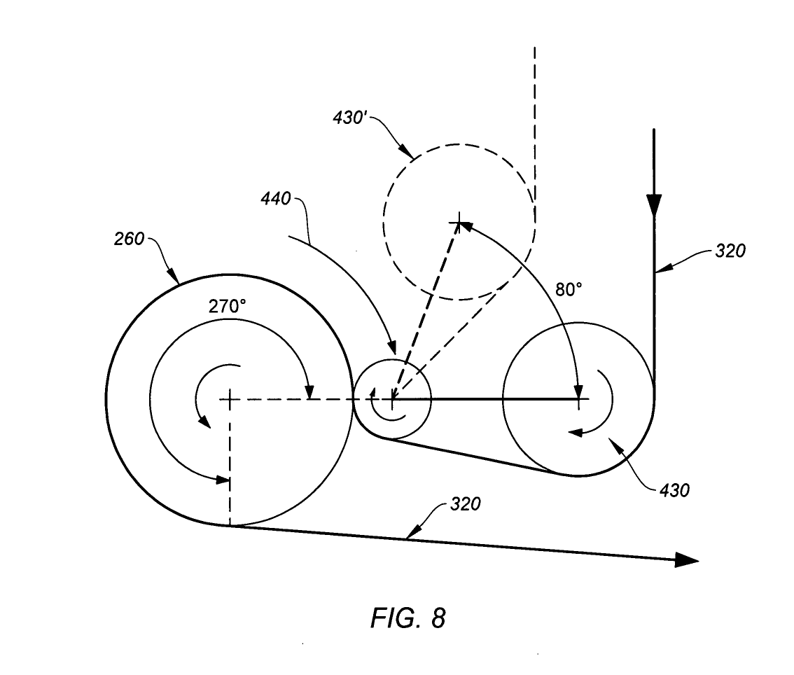

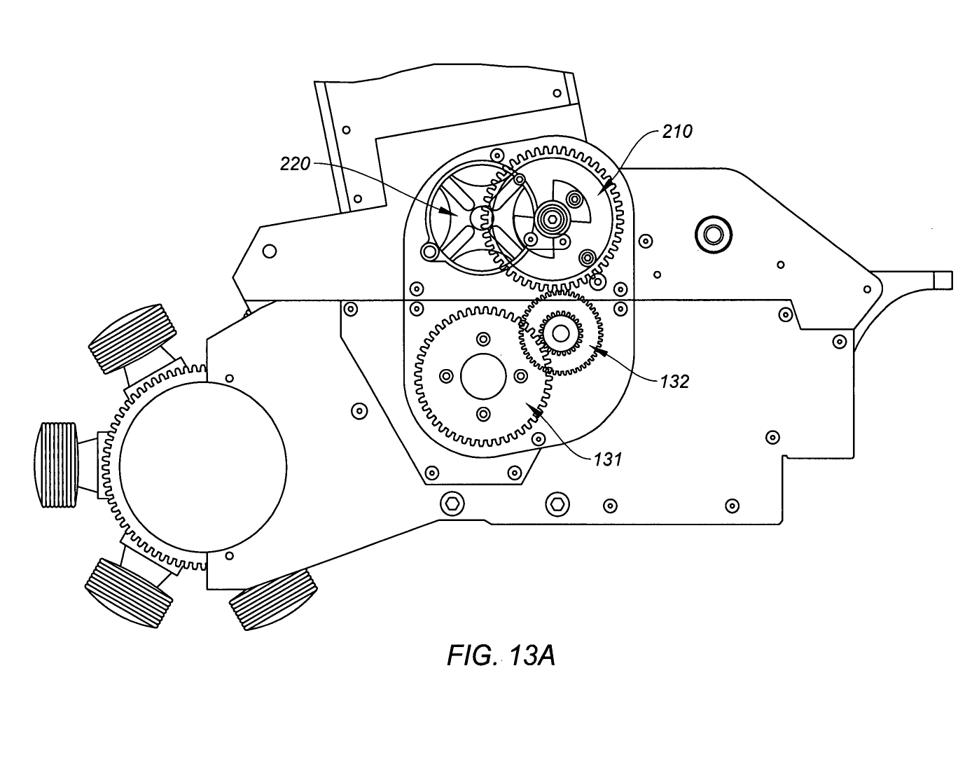

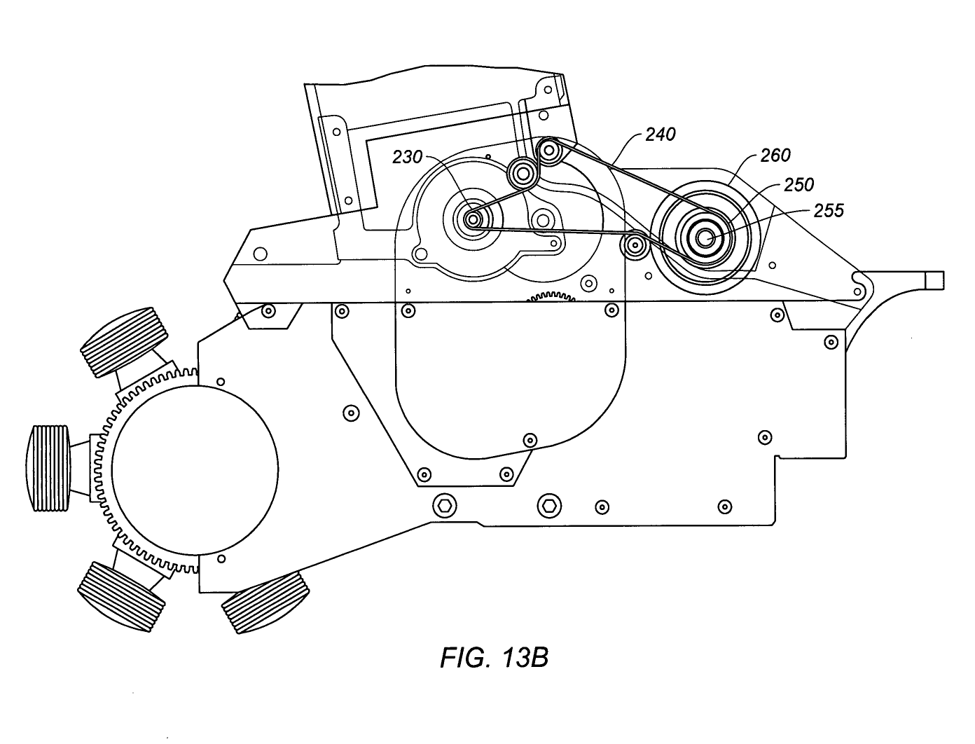

Output wheel 220 carries a cassette drive pulley 230. Drive pulley 230 has 16 teeth (not shown for clarity). A belt 240 transfers rotary drive power from Geneva output wheel 220 to a cassette scallop pulley 250. Scallop pulley 250 is a “quick change” pulley to adapt the cassette drive mechanism to apply different sized labels, as shown and described further below. Scallop pulley 250 is carried by shaft 255 (FIG. 13B). Scallop wheel 260 is also carried by shaft 255, and rotates with removable pulley 250. Scallop wheel 260 carries label carrier strip 320 and causes it to advance (FIG. 8).

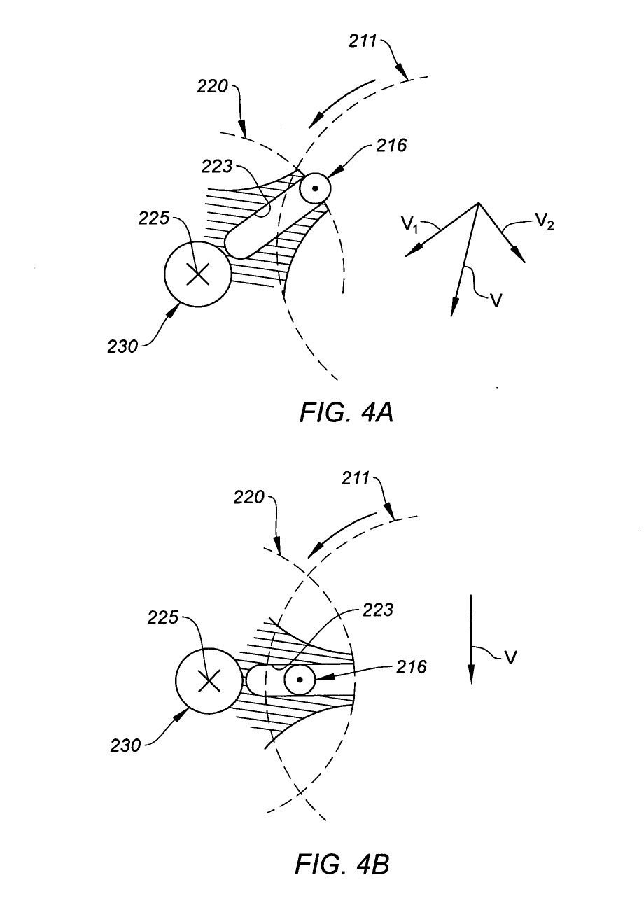

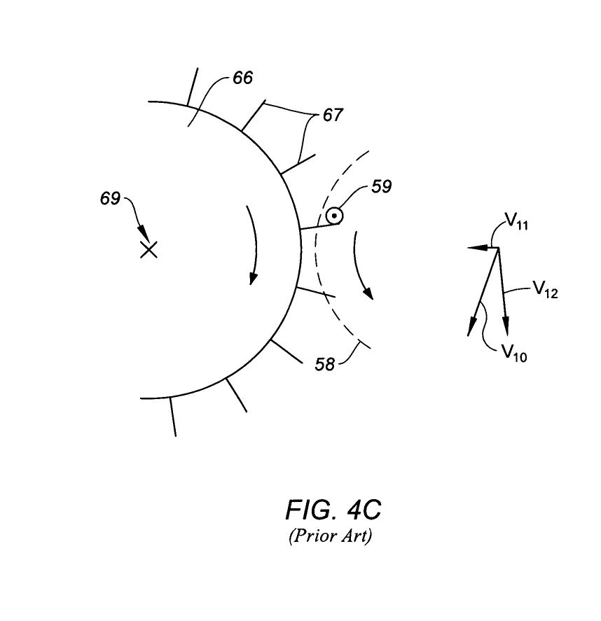

FIG. 4A, 4B and 5 illustrate how the Geneva drive assembly imparts a significantly different pattern of rotational acceleration and speed to drive pulley 230 in a single label dispense cycle, as compared with a prior art system without the Geneva wheel assembly 200.

As shown in FIG. 4A, as Geneva drive pin 216 first enters slot 223, pin 216 imparts relatively low rotational speed from output wheel 220 to slot 223 and drive pulley 230. This is due to the fact that the motion of pin 216 has a significant vectoral directional component Vi towards the axis 225 of output wheel 220.

As shown in FIG. 4B, as pin 216 reaches maximum depth in slot 223, its direction of motion V has no vectoral component in the direction toward axis 225. At this point, maximum rotational speed is imparted to output wheel 220 and pulley 230.

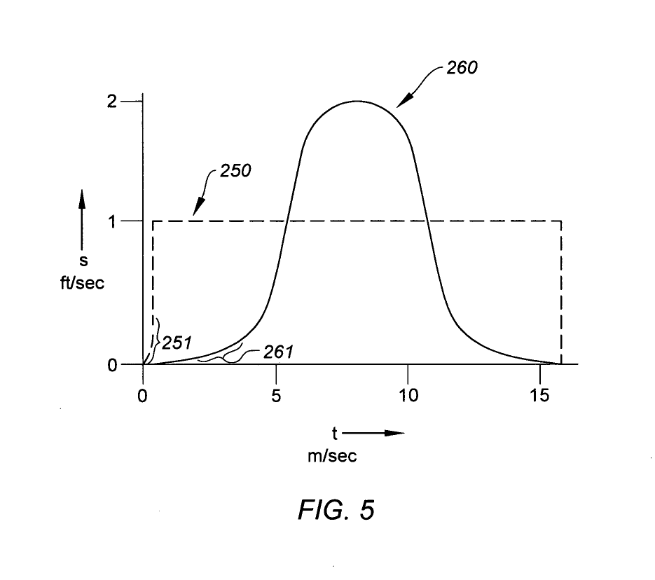

FIG. 5 is a graphical representation, not to scale, illustrating the differences between a drive system with and without the improved Geneva wheel assembly for a single label dispense or application cycle, which lasts less than 17 milliseconds.

The dashed line 250 illustrates the speed imparted to the label drive, and to the label carrier strip, by a prior art system (such as shown by the '775 patent) without the present invention during a single cycle of about 17 milliseconds (1,000 labels per minute), wherein the prior art system is attempting to achieve a labeling speed of 1,000 labels per minute per lane. In the first 1-3 milliseconds, the rotational speed increases from zero to about one foot per second by a stepper motor drive such as in the '755 patent, and remains constant until the last few milliseconds, when it drops back to zero. The significant aspect of line 250 is the large acceleration, or “jerk,” early in the cycle, shown as 251. This large acceleration causes tearing and/or slipping of the label carrier strip.

Line 260 illustrates the speed imparted to the label drive, and to the label carrier strip, by the Geneva wheel assembly 200 of the present invention during each step of the stepper motor, wherein the label carrier strip is advanced the length of a label, constituting a label dispense cycle. The labels are transferred to the bellows of the rotary head as known in the art. A much lower acceleration is imparted in the first several milliseconds of the cycle, shown as 261, significantly reducing the amount of jerk applied to the label carrier strip. The reduced initial acceleration or jerk, shown as 261, as the stepper motor “steps,” is substantially reduced and believed to be more than 40% less than the jerk 251 imparted to the label carrier strip 320 in the absence of the present, improved Geneva drive assembly. The present invention minimizes the jerk imparted to the label carrier strip 320 as the stepper motor steps, or indexes. The speed shown by line 260 rises with rapid acceleration during the next portion of the cycle to roughly twice the speed of line 250, which compensates for the lower speed achieved by line 260 early in the cycle. The Geneva wheel assembly, in effect, greatly reduces jerk imparted to the label carrier strip early in each cycle, but achieves greater acceleration and rotational speed in mid-cycle, to achieve greater overall labeling speeds.

As shown in FIGS. 3, 4A and 4B, the output wheel 220 rotates through an arc “A” of at least 90° for each label dispense cycle. We believe that the relative sizes and placement of input wheel 210 and output wheel 220, together with the depth of slots 221-224 on output wheel 220 and the placement of pins 215 and 216 on input wheel must be such that output wheel 220 must rotate 90° or more for each label dispense cycle to take advantage of the speed and acceleration characteristics for each label dispense cycle shown in FIG. 5. If output wheel 220 is rotated at least 90 degrees in each label dispense cycle, we believe the jerk applied to the label carrier strip is reduced substantially by at least 40 percent.

As shown in FIG. 4A, the output wheel must rotate through a large enough arc “A” with each label dispense cycle so that at the beginning of each cycle, the drive pin has a significant vectoral directional speed component V₁ of at least 75% of the total vectoral speed V of the pin in the direction toward the axis of rotation 225 of the output wheel 220. This directional speed component V₁ provides substantially reduced acceleration or jerk at the beginning of each cycle as noted above.

FIG. 4C is a schematic representation of the Geneva drive shown in U.S. Pat. No. 2,528,856. Input wheel 58 carries pin 59, which causes vanes 67 of output wheel 66 to rotate approximately 25 to 30 degrees in each cycle. Vector V₁₀ represents the overall speed and direction of pin 59 as pin 59 first contacts a vane 67. Vector V₁₁ represents a component of V₁₀ in the direction from pin 59 toward the axis of rotation 69 of wheel 66. We believe the relative size of V₁₁ to V₁₀ represents the degree to which jerk is reduced. As shown in FIG. 4C, V₁₁ is about 25 percent of V₁₀. As shown in FIG. 4A, V₁ is approximately 75 percent of V. We believe that by increasing this ratio threefold, the jerk is reduced by approximately two thirds, or about 67 percent. The reduced jerk is achieved by rotating output wheel at least 90 degrees with each label dispense cycle.

We believe the jerk of the label carrier strip with the present system is reduced at least 40 percent compared to known produce labelers of Sinclair Systems International, LLC, and compared to the system of U.S. Pat. No. 6,047,755.

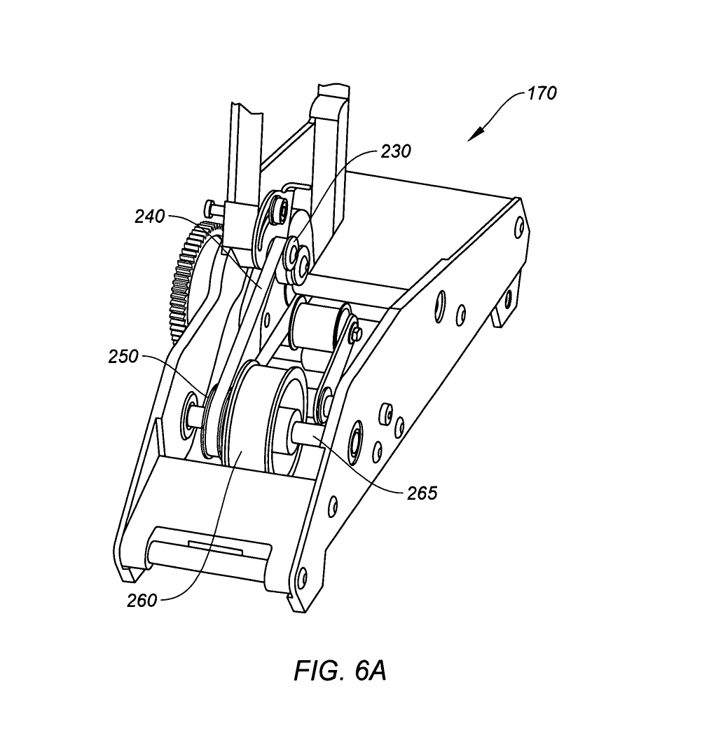

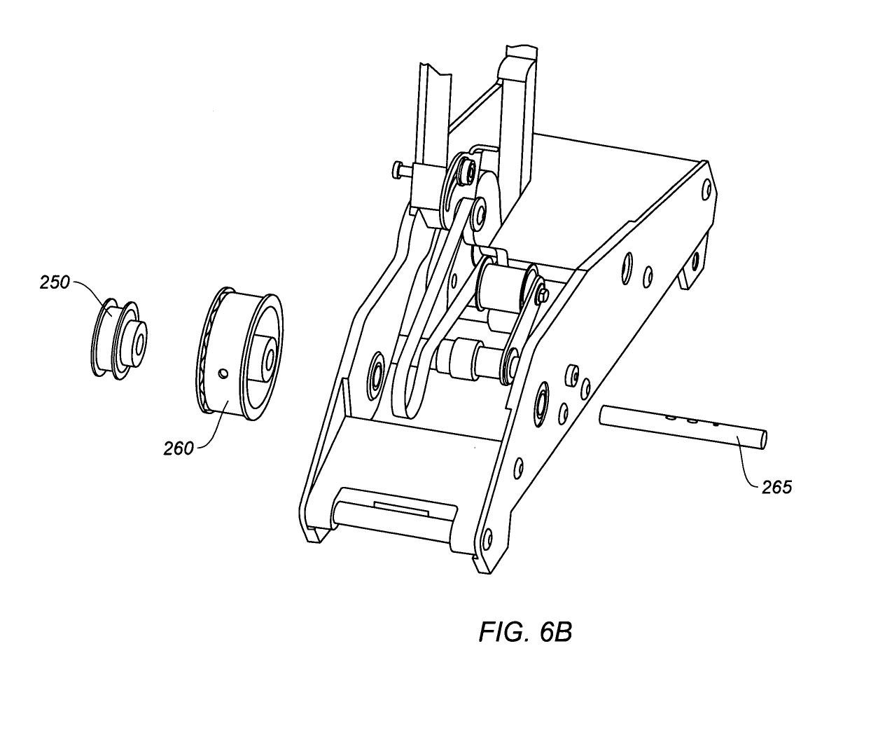

As shown in FIGS. 6A and 6B, the present invention can be readily adapted to accept and utilize different size labels. The cassette 170 in FIG. 6A is opened, a new scallop wheel pulley 250 and drive belt 240 are inserted and the scallop wheel 260 is either adjusted or changed. Modifying the cassette can be done without stopping the labeling machine, avoiding down time. Also, the cassette is much easier to work on than the rotary head drive mechanism. The rotary head drive of the present invention does not require any modification, as is the case with the prior art.

The pulley and scallop wheel replacement can be done in a matter of minutes prior to placing the cassette on the applicator, reducing down time of the applicator.

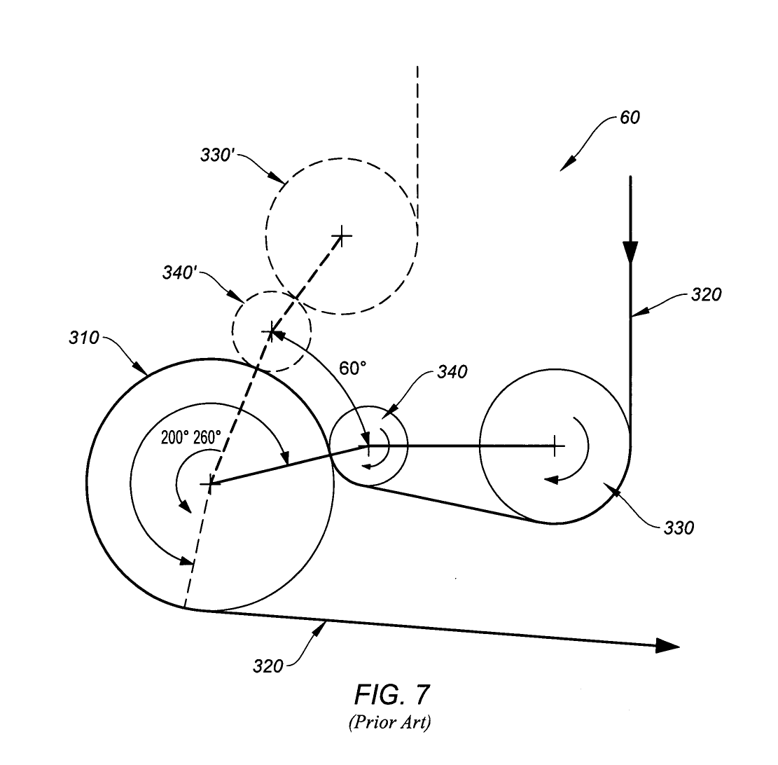

FIGS. 7 and 8 illustrate the differences between the cassette tensioning mechanism of the prior art (FIG. 7) compared with the improved tensioning mechanism of the present invention.

FIG. 7 shows the tensioning system used in a prior art cassette system (FIG. 1). A scallop wheel 310 rotates counter-clockwise as it is driven by a prior art indexing clutch (not shown). Label carrier strip 320 runs over tension roller 330, nip roller 340 and then over scallop wheel 310 prior to being fed to the stripper plate (not shown).

As tension is applied to label carrier strip 320, the nip roller 340 and tension roller 330 move, in a counter-clockwise direction to the positions shown in phantom as 340′ and 330′. As the nip roller 340 and tension roller move to the phantom positions, the amount of frictional contact between label carrier strip 320 and the surface of scallop wheel 310 drops from about 260 degrees to about 200 degrees of the scallop wheel circumference. This motion of nip roller 340 and tension roller 330, when driven by a prior art drive system at speeds of about 1,000 feet per minute causes a jerking of the label carrier strip that can tear the strip and/or cause slippage of the strip on the surface of scallop wheel 310. Both of the scenarios almost always cause extensive labeling down time.

FIG. 8 illustrates the improved tensioning system. The nip roller 440 remains fixed at a position where it holds label carrier strip 320 against the surface of scallop wheel 260 through an arc of about 270 degrees. As tension is applied to the label carrier strip 320, tension roller 430 moves counter-clockwise through an arc of about 80 degrees to position 430′ shown in phantom.

The improved tensioning system of FIG. 8 holds the label carrier strip 320 against scallop wheel 260 over a constant arc of about 270 degrees. The prior art system of FIG. 7 fluctuates between an arc of about 200 degrees to about 260 degrees. Also, the improved nip roller 440 remains stationary and the motion of tensioning roller 430 is reduced, resulting in reduced inertia of both rollers when tension is applied. The combination of reduced inertia of the rollers and a steady pressure of the label carrier strip 320 over a constant arc of about 270 degrees of scallop wheel 260 reduces the jerking, tearing and/or slipping of strip 320 on scallop wheel 260.

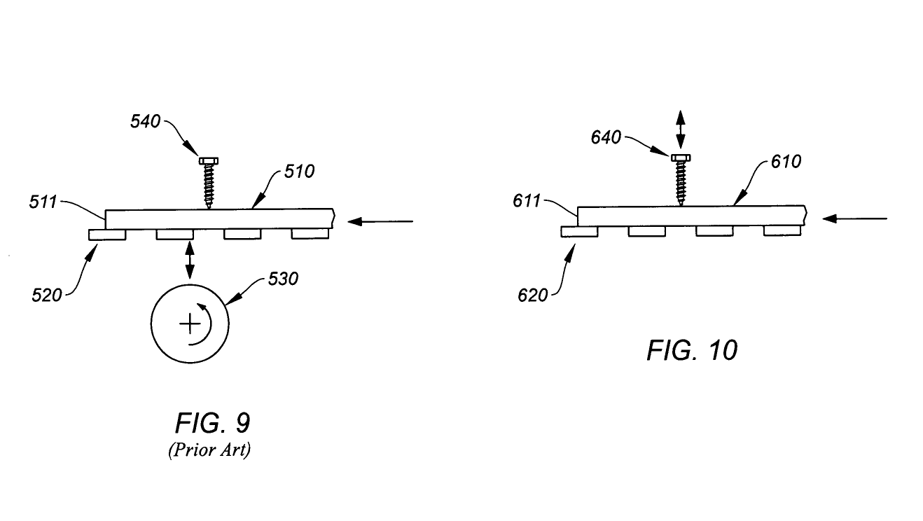

FIG. 9 is a “concept” sketch illustrating a typical prior art stripper plate 510 (similar to that shown and described in La Mers U.S. Pat. No. 4,217,164). As a label 520 is being stripped, cam 530 rotates to a position lifting stripper plate 510. A fixed screw 540 above stripper plate 510 causes only its tip end 511 to be lifted by cam 530.

FIG. 10 is a “concept” sketch showing the present stripper plate 610. It is significant that the cam 430 is eliminated. An adjustable screw 640 replaces fixed screw 540. Adjustable screw 640 allows the tip 611 of stripper plate 610 enough freedom of motion to allow labels 620 to be reliably stripped at high speeds of 1,000 labels per minute.

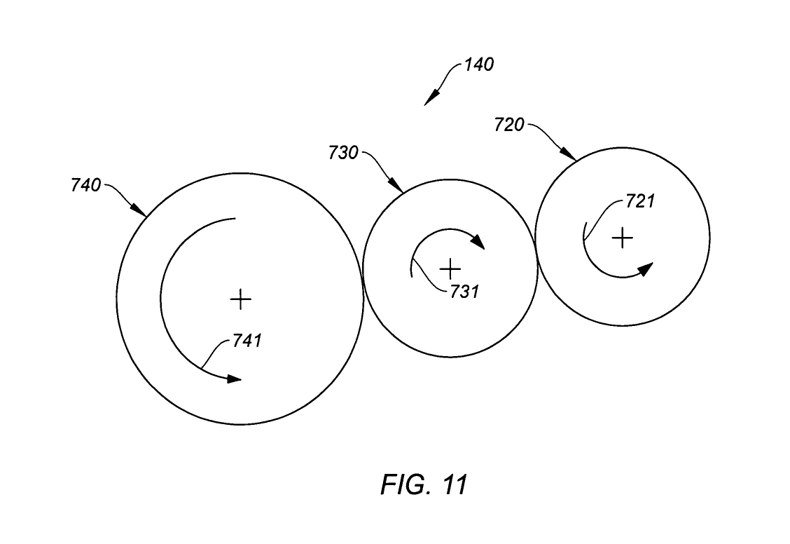

FIG. 11 illustrates the second direct gear drive 140 for the rotary head (not shown). Motor gear 720 in the preferred embodiment utilizes 48 teeth (not shown) and rotates counterclockwise as shown by arrow 721. Motor gear 720 is driven by a stepper motor not shown in FIG. 11 for clarity.

Motor gear 720 drives an idler gear 730. Idler gear 730 has 48 teeth (not shown) and rotates clockwise as shown by arrow 731.

Idler gear 730 drives output gear 740, which in the preferred embodiment has 72 teeth (not shown) and rotates counterclockwise, as shown by arrow 741. Output gear 740 drives the rotary head (not shown).

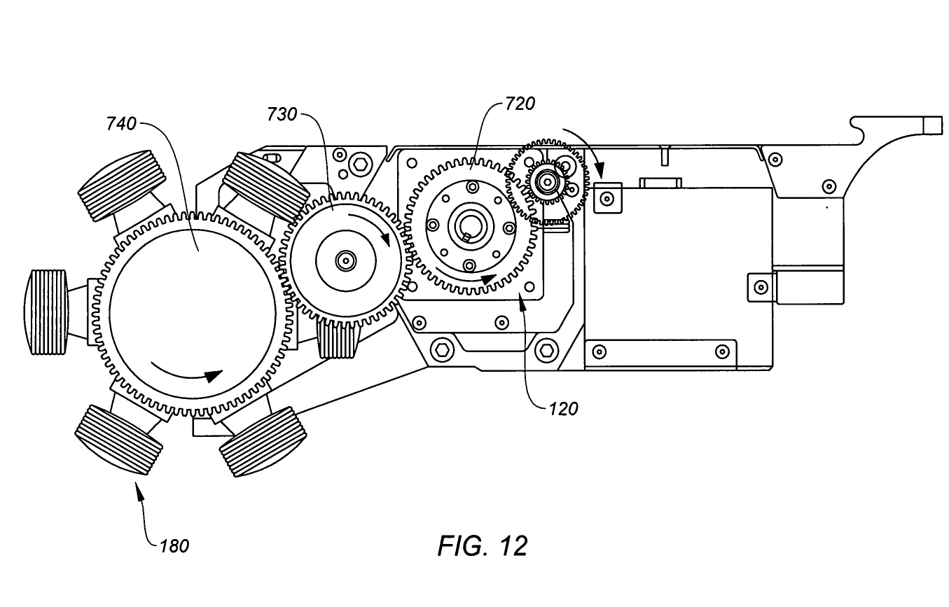

FIG. 12 is an assembly drawing of the housing for the direct gear drive train 140 shown in FIG. 11, with the housing wall broken away for clarity. Stepper motor 120 is also shown in FIG. 12. FIGS. 11 and 12 illustrate how rotary head 180 is connected to and driven by gears 720, 730 and 740.

FIG. 13A is an assembly drawing of the housing for the cassette gear drive shown in FIG. 3, with the housing wall broken away for clarity.

FIG. 13B is an assembly drawing with the gear drive of FIG. 13A not shown to illustrate the placement of cassette drive pulley 230, belt 240, cassette scallop pulley 250 and scallop wheel 260. As noted above, the “quick change” parts include cassette scallop pulley 250, belt 240 and scallop wheel 260.

The diameter of the bellows is preferably reduced, in order to reduce the volume of air needed to extend each bellow, facilitating increased labeling speed. The cross-sectional diameter of a retracted bellow is reduced by approximately 25% from a diameter of about 60 mm to a preferred diameter of between 40 mm and 50 mm.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated.

1. An automatic, high speed produce labeler capable of dispensing and applying labels to 1,000 produce items per lane per minute, wherein said labeler includes a rotary head carrying a plurality of flexible bellows, and a removable label cassette carrying a label carrier strip, comprising:
a stepper motor
a first direct gear drive train connected to and driven by said stepper motor wherein said first direct gear drive train includes a Geneva wheel assembly, said Geneva wheel assembly including an input wheel and an output wheel,
said label cassette connected to and driven by said Geneva output wheel,
a second direct gear drive train connected to and driven by said stepper motor
said rotary head connected to and driven by said second gear drive train
whereby said first gear drive train with said Geneva wheel assembly advances said label carrier strip the length of a label for each step of said stepper motor, wherein each advance of said label carrier strip constitutes a label dispense cycle, and said labeler is capable of dispensing up to apply 1,000 labels per minute to be applied to produce items in a single lane by said rotary head and
wherein said input and output wheels of said Geneva wheel assembly are sized and placed so that said output wheel is rotated through at least a ninety degree arc in a single label dispense cycle,
whereby the jerk applied to said label carrier strip is reduced by at least 40% of the jerk otherwise imparted to the label carrier strip by the prior art.

2. The apparatus of claim 1 wherein said produce labeler is capable of applying labels of different sizes, and wherein said label cassette comprises:
a quick-change drive pulley,
a quick-change scallop wheel,
a quick-change drive belt, and
wherein said quick-change drive pulley, scallop wheel and drive belt can be changed to allow said labeler to apply different size labels, without having to stop operation of said rotary head.

3. The apparatus of claim 2 wherein said label carrier strip passes over the surface of said scallop wheel, further comprising:
a tensioning system for said label carrier strip comprising a movable tensioning roller and a nip roller wherein said nip roller remains stationary and holds said label carrier strip against the surface of said scallop wheel over an arc of at least 270 degrees, and said tensioning roller moves with each label dispense cycle to maintain tension on said label carrier strip.

4. The apparatus of claim 1 further comprising a stripper plate having a tip end against which labels are stripped from said label carrier strip, wherein an adjustable stop screw is positioned to allow sufficient flexing of said tip to strip said labels, whereby a cam otherwise required to cause said tip to flex is eliminated.

5. An automatic, high speed produce labeler capable of applying labels of different sizes, wherein said labeler includes a rotary head carrying a plurality of flexible bellows, a removable label cassette carrying a label carrier strip wherein a stepper motor actuates a direct gear drive train connected to and driven by said stepper motor, wherein a Geneva wheel assembly is connected to and driven by said first direct gear drive train and wherein a label cassette is connected to and driven by said Geneva wheel assembly, characterized by:
said label cassette having a quick change drive pulley, scallop wheel and drive belt,
said first and second gear drive trains and said Geneva wheel assembly operate at high speed to dispense and apply 1,000 labels per minute to produce items in a single lane,
whereby said quick-change drive pulley, scallop wheel and drive belt of said label cassette allows said apparatus to be capable of being adapted to apply different size labels without having to stop operation of said rotary head, and
wherein said Geneva wheel assembly includes an input and output wheel, and said wheels are sized and placed so that said output wheel is rotated through at least a ninety degree arc for each label dispense cycle.

6. The produce labeler of claim 5 wherein a tensioning system is used to maintain tension in said label carrier strip, wherein said tensioning system includes a tensioning roller and a nip roller, further characterized by:
said nip roller remains stationary and holds said label carrier strip against the surface of said scallop wheel over an arc of at least 270 degrees, and said tensioning roller moves with each label dispense cycle to maintain tension on said label carrier strip.

7. The produce labeler of claim 5 wherein a stripper plate has a tip end against which labels are stripped from said label carrier strip, further characterized by:
an adjustable stop screw being positioned to allow sufficient flexing of said tip end of said stripping plate to strip said labels, whereby no cam is necessary to cause flexing of said tip to strip said labels.

8. A method of automatically applying labels to 1,000 produce items per lane per minute, wherein said labeler includes a rotary head carrying a plurality of flexible bellows, a removable label cassette carrying a label carrier strip, a stepper motor, a first direct gear drive train connected to and driven by said stepper motor, a Geneva wheel assembly including an input wheel and an output wheel connected to and driven by said first direct gear drive train, said label cassette connected to and driven by said Geneva output wheel, a second direct gear drive train connected to and driven by said stepper motor, said rotary head connected to and driven by said second gear drive train comprising the steps:
causing said stepper motor to rotate through index steps wherein each index step is a label dispense cycle lasting less than 17 milliseconds,
transferring each said rotary index step of said stepper motor through said first direct gear drive train to rotate said Geneva input wheel,
said Geneva input drive wheel causing said Geneva output wheel to rotate through an arc of at least 90 degrees for each said label dispense cycle,
said Geneva driven wheel causing said label carrier strip to advance a distance equal to the length of a label to be applied in each label dispense cycle,
wherein for each label dispense cycle of less than 17 milliseconds said Geneva driven wheel imparts at least 40% reduced jerk of said label carrier strip at the beginning of each label dispense cycle compared with the prior art, thereby minimizing the tearing or slipping of said label carrier strip and facilitating the dispensing and application of 1,000 labels per minute for a single rotary head.
